(19) United States
(12) Patent Application Publication
(10) Pub. No.: US 2009/0224507 A1
(43) Pub. Date: Sep. 10, 2009

(54) Head tube for a bicycle frame

(75) Inventor: Samuel Hu, Changhua City (TW)

Correspondence Address: BACON & THOMAS, PLLC, 625 SLATERS LANE, FOURTH FLOOR, ALEXANDRIA, VA, 22314-1176, US

(73) Assignee: ASTRO ENGINEERING CO., LTD., Changhua City (TW)

(21) Appl. No.: 12/073,596

(22) Filed: Mar. 7, 2008

(51) Int. Cl. B62K 3/02

(52) U.S. Cl. 280/279

(57) ABSTRACT

A head tube for a bicycle frame is aluminum alloy, is formed by stamping an aluminum alloy sheet, which may have an equal thickness or may be a special-shaped sheet having an unequal thickness, and has a rear side, an outer surface, a seam, a soldering layer and at least one bossed pattern. The seam is formed longitudinally on the rear side of the head tube. The soldering layer is formed in the seam of the head tube. The at least one bossed pattern is formed on the outer surface of the head tube and is non planar with the head tube. Because the head tube is formed by stamping, the at least one bossed pattern with intricate edges or corners can be formed easily on the outer surface of the head tube with low manufacturing costs to give the head tube an appeasing aesthetic appearance.

### BACKGROUND OF THE INVENTION

1. Field of Invention

The present invention relates to a component of a bicycle frame, and more particularly to a head tube for a bicycle frame.

2. Description of the Related Art

A bicycle frame is designed with suitable structural intensity and rigidity to achieve high safety and riding quality. Furthermore, the frame provides space for a manufacturer to brand their product and consumers to be attracted to this brand whilst shopping and in use. Especially important is aesthetic beauty of the head tube, being at a front the head tube is often all that is visible in shops.

Various techniques are developed to aesthetically improve the head tube of the bicycle frame, including forging and hydroforming. Forging involves forming a solid semifinished product, forging the semifinished product to form a shaped protrusion on an outer surface of the semifinished product and then forming a head tube from the semifinished product. However, this requires obtaining a die and a forge hammer with a shape of the shaped protrusion. Additionally, a through hole must be further drilled to completely form the head tube. Therefore, manufacturing processes are complicated, intricate edges and corners are hard to form on the conventional head tube and forging causing high material wastage.

Another technique is to shape a conventional head tube of a bicycle frame by hydroforming to form an embossed pattern of an outer surface of the head tube. However, hydroforming equipment is expensive, causing raised manufacturing costs. Further, using hydroforming to form an intricate shape is also hard.

To overcome the shortcomings, the present invention provides a head tube for a bicycle frame to mitigate or obviate the aforementioned problems.

### SUMMARY OF THE INVENTION

The primary objective of the present invention is to provide a head tube for a bicycle frame having at least one intricate shape on the head tube with low manufacturing costs.

A head tube for a bicycle frame in accordance with the present invention is aluminum alloy, is formed by stamping and has a rear side, an outer surface, a seam, a soldering layer and at least one bossed pattern. The seam is formed longitudinally on the rear side of the head tube. The soldering layer is formed on the seam of the head tube. The at least one bossed pattern is formed on the outer surface of the head tube and is non planar with the head tube. Because the head tube is formed by stamping, at least one bossed pattern with intricate edges or corners can be formed easily on the outer surface of the head tube with low manufacturing costs to give the head tube an appeasing aesthetic appearance.

Other objectives, advantages and novel features of the invention will become more apparent from the following detailed description when taken in conjunction with the accompanying drawings.

### BRIEF DESCRIPTION OF THE DRAWINGS

FIG. 1 is a series of front perspective diagrams showing formation of a head tube for a bicycle frame in accordance with the present invention;

FIG. 2 is a series of rear perspective diagrams showing formation of the head tube for a bicycle frame in FIG. 1;

FIG. 3 is a rear view of the head tube for a bicycle frame in FIG. 1;

FIG. 4 is a top operational view of a step of tube forming;

FIG. 5 is a rear view of the head tube for a bicycle frame with the soldering layers;

FIG. 6 is a perspective view of the head tube for a bicycle frame with the top tube an the down tube; and

FIG. 7 is a series of front perspective diagrams showing formation of the head tube for a bicycle frame in FIG. 1, the head tube further comprising a cutout.

### DETAILED DESCRIPTION OF THE INVENTION

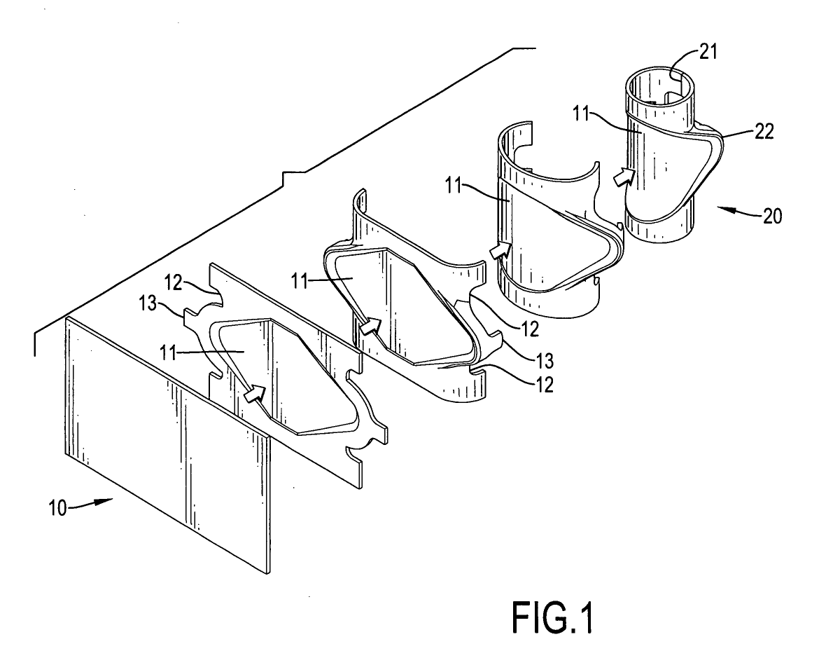

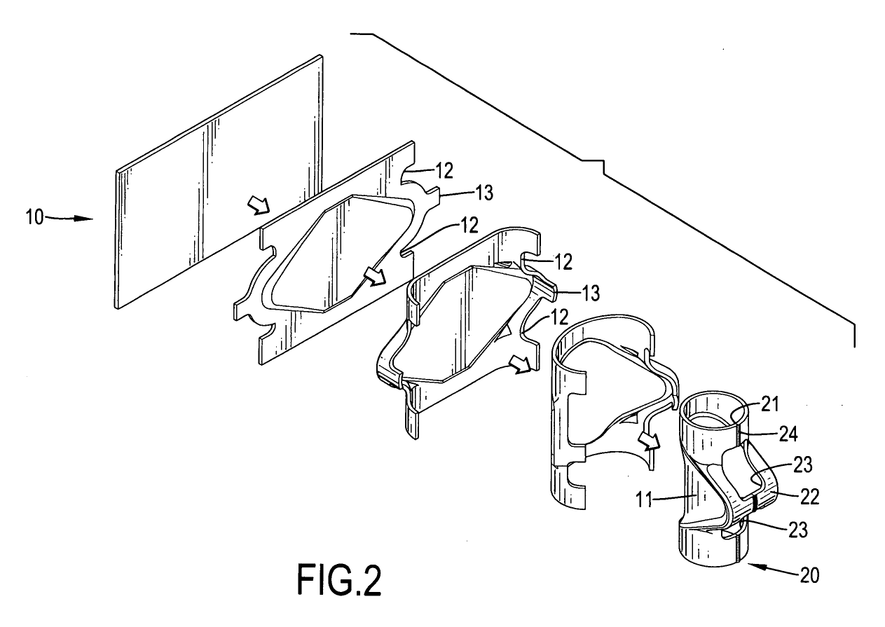

With reference to FIGS. 1 and 2, a head tube for a bicycle frame in accordance with the present invention is manufactured by steps of: obtaining an aluminum alloy sheet, stamping, tube forming, and soldering.

In the step of obtaining an aluminum alloy sheet, the aluminum alloy sheet (10) is highly ductile to facilitate stamping and has an outer surface, an inner surface and two sides. The aluminum alloy sheet (10) may have an equal thickness or may be a special-shaped sheet having an unequal thickness.

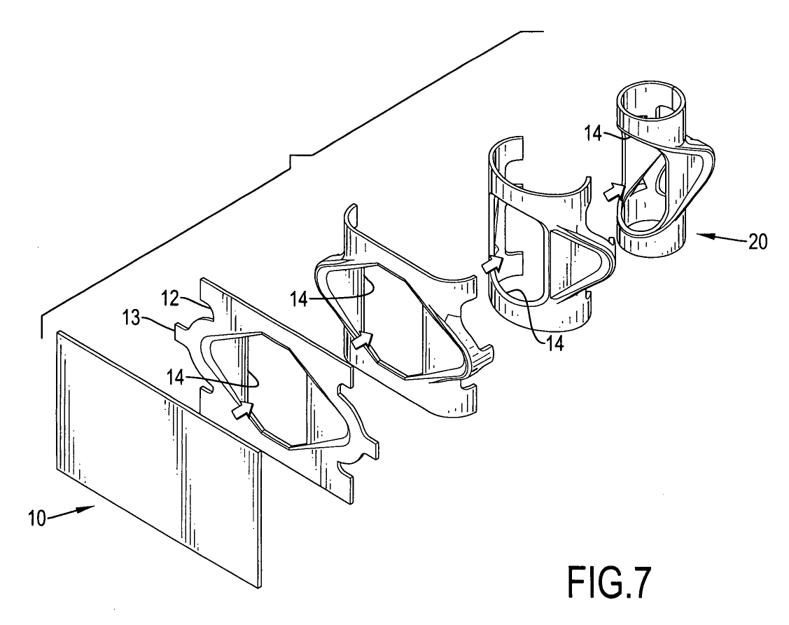

With further reference to FIG. 7, in the step of stamping, the aluminum alloy sheet (10) is stamped to form at least one bossed pattern (11), at least one optional protrusion (13) and multiple optional recesses (12). The at least one bossed pattern (11) is formed from the outer surface of the aluminum alloy sheet (10), may be embossed or debossed, may be hexangular and has a depth. The depth may increase from a central segment towards the sides of the aluminum alloy sheet (10). Each protrusion (13) is formed on one side of the aluminum alloy sheet (10). Two recesses (12) are formed in the aluminum alloy sheet (10) adjacent to and sandwiching the protrusion (13).

The step of stamping may comprise a first stamping and a second stamping. The first stamping forms one bossed pattern (11) and may further form four optional recesses (12), two optional protrusions (13) and a cutout (14). The bossed pattern (11) is hexangular and debossed from the outer surface of the aluminum alloy sheet (10). The protrusions (13) are respectively formed on the sides of the aluminum alloy sheet (10). Two recesses (12) are formed adjacent to and sandwich each protrusion (13). The cutout (14) is formed in and removed from the bossed pattern (11).

The second stamping bends the sides of the aluminum alloy sheet (10) toward the inner surface of the aluminum alloy sheet (10).

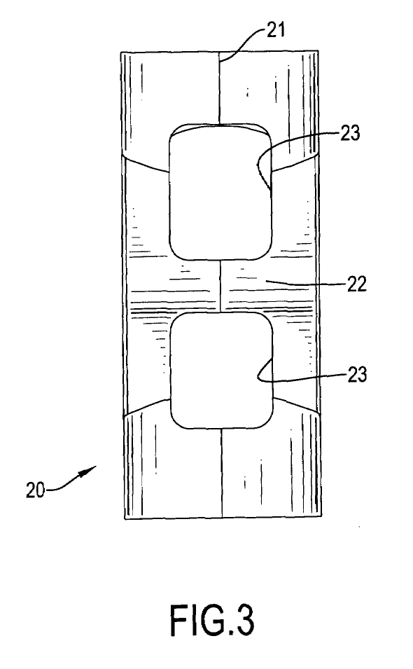

With further reference to FIG. 3, in the step of tube forming, the aluminum alloy sheet (10) is bent and the sides of the aluminum alloy sheet (10) are joined together to form the head tube (20). The head tube (20) has a rear side, an outer surface, a seam (21), at least one bossed pattern (11), an optional strengthening member (22) and two optional openings (23). The seam (21) is formed longitudinally on the rear side of the head tube (20) by joining the sides of the aluminum alloy sheet (10) together. The at least one bossed pattern (11) is formed from and non planer with the outer surface of the head tube (20) and may be debossed from the outer surface of the head tube (20). The strengthening member (22) is formed by joining each protrusion (13) to one side of the aluminum alloy sheet (20), may be by joining two protrusions (13) together, protrudes from the outer surface of the head tube (20) and has two sides and a seam. The openings (23) are formed by the recesses (12) and are disposed adjacent to and sandwiching the strengthening member (22).

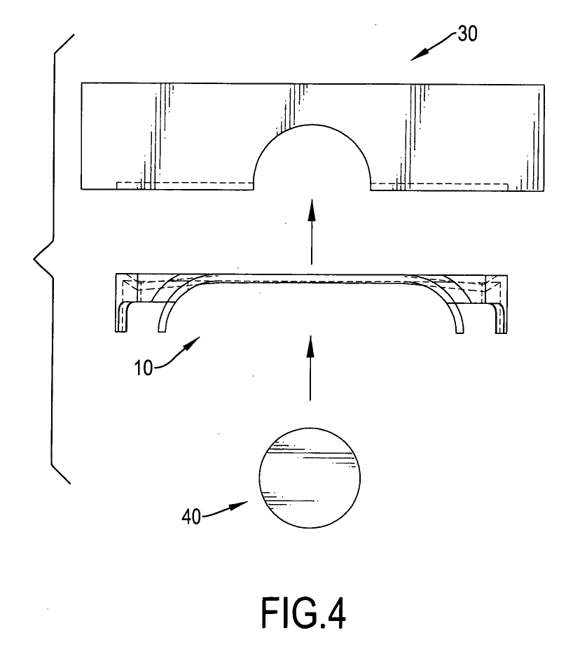

With further reference to FIG. 4, the aluminum alloy sheet (10) can be bent using a die (30) having a semicircular cavity and a cylindrical core (40) to form the head tube (20).

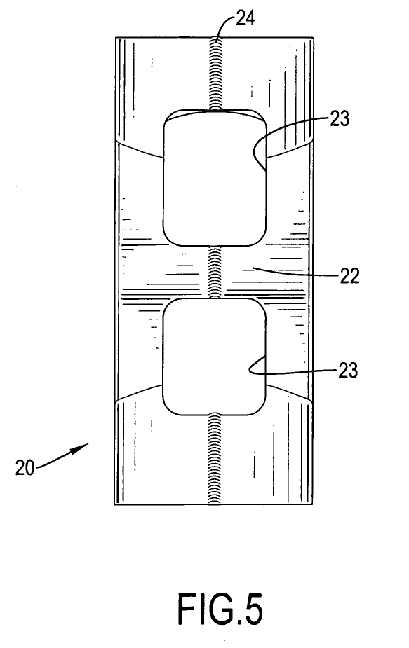

With further reference to FIG. 5, in the step of soldering, the seam (21) of the head tube (20) is soldered to form a soldering layer (24) at the seam (21) of the head tube (20). Preferably, the seam of the strengthening member (22) is soldered to form a soldering layer at the seam of the strengthening member (22).

The head tube (20) for a bicycle frame in accordance with the present invention is aluminum alloy and has a rear side, an outer surface, a seam (21), a soldering layer (24), at least one bossed pattern (11), an optional strengthening member (22) and two optional openings (23). The seam (21) is formed longitudinally on the rear side of the head tube (20). The soldering layer (24) is formed at the seam (21) of the head tube (20). The at least one bossed pattern (11) is formed from the outer surface of the head tube (20) and is non planar with the outer surface of the head tube (20). Preferably, one bossed pattern (11) is implemented. The bossed pattern may be debossed or embossed from the outer surface of the head tube (20), may be hexagonal and may have a cutout (14).

The strengthening member (22) protrudes from the outer surface of the head tube (20) and has a seam and a soldering layer formed at the seam. The openings (23) are disposed respectively adjacent to and sandwiching the strengthening member (22).

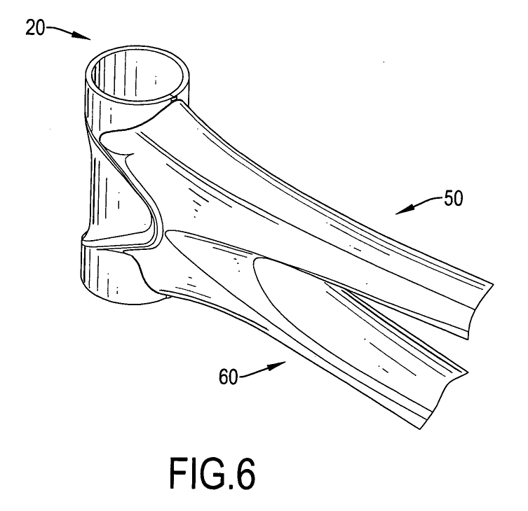

With further reference to FIG. 6, the head tube (20) can be connected to a top tube (50) and a down tube (60) to further form a bicycle frame. Preferably, the tubes (50, 60) have an end connected to the rear side of the head tube (20) respectively around one of the openings (23) of the head tube (20). Because the at least one bossed pattern (11) can be formed easily on the outer surface of the head tube (20) without expensive hydroforming equipment or complicated manufacturing processes, manufacturing costs are low. Furthermore, the at least one bossed pattern (11) with intricate edges and corners can be formed easily by stamping so that the head tube (20) in accordance with the present invention is aesthetically appealing to consumers.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A head tube for a bicycle frame being aluminum alloy and having
a rear side;
an outer surface;
a seam being formed longitudinally on the rear side of the head tube;
a soldering layer being formed at the seam of the head tube; and
at least one bossed pattern being formed from the outer surface of the head tube and being non planar with the outer surface of the head tube.

2. The head tube for a bicycle frame as claimed in claim 1 further having a strengthening member protruding from the outer surface of the head tube and having a seam and a soldering layer formed at the seam of the strengthening member.

3. The head tube for a bicycle frame as claimed in claim 2 further having two openings disposed respectively in adjacent to and sandwiching the strengthening member.

4. The head tube for a bicycle frame as claimed in claim 3, wherein the head tub has one bossed pattern having a cutout.

5. The head tube for a bicycle frame as claimed in claim 1, wherein the head tube has one bossed pattern having a cutout.

6. The head tube for a bicycle frame as claimed in claim 2, wherein the head tube has one bossed pattern having a cutout.
